(19) United States
(12) Patent Application Publication
(10) Pub. No.: US 2021/0397963 A1
(43) Pub. Date: Dec. 23, 2021

(54) METHOD AND APPARATUS FOR NEURAL NETWORK MODEL COMPRESSION WITH MICRO-STRUCTURED WEIGHT PRUNING AND WEIGHT UNIFICATION

(71) Applicant: TENCENT AMERICA LLC, Palo Alto, CA (US)

(72) Inventors: Wei JIANG, San Jose, CA (US); Wei WANG, San Jose, CA (US); Sheng LIN, San Jose, CA (US); Shan LIU, Palo Alto, CA (US)

(73) Assignee: TENCENT AMERICA LLC, Palo Alto, CA (US)

(21) Appl. No.: 17/319,313

(22) Filed: May 13, 2021

Related U.S. Application Data
(60) Provisional application No. 63/040,216, filed on Jun. 17, 2020.
(60) Provisional application No. 63/040,238, filed on Jun. 17, 2020.
(60) Provisional application No. 63/043,082, filed on Jun. 23, 2020.

(51) Int. Cl. G06N 3/08; G06N 3/04

(52) U.S. Cl. CPC G06N 3/082; G06N 3/04

(57) ABSTRACT

A method of neural network model compression is performed by at least one processor and includes receiving an input neural network and an input mask, and reducing parameters of the input neural network, using a deep neural network that is trained by selecting pruning micro-structure blocks to be pruned, from a plurality of blocks of input weights of the deep neural network that are masked by the input mask, pruning the input weights, based on the selected pruning micro-structure blocks, selecting unification micro-structure blocks to be unified, from the plurality of blocks of the input weights masked by the input mask, and unifying multiple weights in one or more of the plurality of blocks of the pruned input weights, based on the selected unification micro-structure blocks, to obtain pruned and unified input weights of the deep neural network.

### CROSS-REFERENCE TO RELATED APPLICATIONS

This application claims priority from U.S. Provisional Patent Application No. 63/040,216, filed on Jun. 17, 2020, U.S. Provisional Patent Application No. 63/040,238, filed on Jun. 17, 2020, and U.S. Provisional Patent Application No. 63/043,082, filed on Jun. 23, 2020, in the U.S. Patent and Trademark Office, the disclosures of which are incorporated by reference herein in their entireties.

### BACKGROUND

Success of Deep Neural Networks (DNNs) in a large range of video applications such as semantic classification, target detection/recognition, target tracking, video quality enhancement, etc. poses a need for compressing DNN models. Therefore, the Motion Picture Experts Group (MPEG) is actively working on the Coded Representation of Neural Network standard (NNR) that is used to encode DNN models to save both storage and computation.

### SUMMARY

According to embodiments, a method of neural network model compression is performed by at least one processor and includes receiving an input neural network and an input mask, and reducing parameters of the input neural network, using a deep neural network that is trained by selecting pruning micro-structure blocks to be pruned, from a plurality of blocks of input weights of the deep neural network that are masked by the input mask, pruning the input weights, based on the selected pruning micro-structure blocks, selecting unification micro-structure blocks to be unified, from the plurality of blocks of the input weights masked by the input mask, and unifying multiple weights in one or more of the plurality of blocks of the pruned input weights, based on the selected unification micro-structure blocks, to obtain pruned and unified input weights of the deep neural network. The method further includes obtaining an output neural network with the reduced parameters, based on the input neural network and the pruned and unified input weights of the deep neural network.

According to embodiments, an apparatus for neural network model compression includes at least one memory configured to store program code, and at least one processor configured to read the program code and operate as instructed by the program code. The program code includes receiving code configured to cause the at least one processor to receive an input neural network and an input mask, and reducing code configured to cause the at least one processor to reduce parameters of the input neural network, using a deep neural network that is trained by selecting pruning micro-structure blocks to be pruned, from a plurality of blocks of input weights of the deep neural network that are masked by the input mask, pruning the input weights, based on the selected pruning micro-structure blocks, selecting unification micro-structure blocks to be unified, from the plurality of blocks of the input weights masked by the input mask, and unifying multiple weights in one or more of the plurality of blocks of the pruned input weights, based on the selected unification micro-structure blocks, to obtain pruned and unified input weights of the deep neural network. The program code further includes obtaining code configured to cause the at least one processor to output an output neural network with the reduced parameters, based on the input neural network and the pruned and unified input weights of the deep neural network.

According to embodiments, a non-transitory computer-readable medium stores instructions that, when executed by at least one processor for neural network model compression, cause the at least one processor to receive an input neural network and an input mask, and reduce parameters of the input neural network, using a deep neural network that is trained by selecting pruning micro-structure blocks to be pruned, from a plurality of blocks of input weights of the deep neural network that are masked by the input mask, pruning the input weights, based on the selected pruning micro-structure blocks, selecting unification micro-structure blocks to be unified, from the plurality of blocks of the input weights masked by the input mask, and unifying multiple weights in one or more of the plurality of blocks of the pruned input weights, based on the selected unification micro-structure blocks, to obtain pruned and unified input weights of the deep neural network. The instructions, when executed by the at least one processor, further cause the at least one processor to obtain an output neural network with the reduced parameters, based on the input neural network and the pruned and unified input weights of the deep neural network.

### BRIEF DESCRIPTION OF THE DRAWINGS

FIG. 1 is a diagram of an environment in which methods, apparatuses and systems described herein may be implemented, according to embodiments.

FIG. 2 is a block diagram of example components of one or more devices of FIG. 1.

FIG. 3 is a functional block diagram of a system for neural network model compression, according to embodiments.

FIG. 4A is a functional block diagram of a training apparatus for neural network model compression with micro-structured weight pruning, according to embodiments.

FIG. 4B is a functional block diagram of a training apparatus for neural network model compression with micro-structured weight pruning, according to other embodiments.

FIG. 4C is a functional block diagram of a training apparatus for neural network model compression with weight unification, according to still other embodiments.

FIG. 4D is a functional block diagram of a training apparatus for neural network model compression with micro-structured weight pruning and weight unification, according to yet other embodiments.

FIG. 4E is a functional block diagram of a training apparatus for neural network model compression with micro-structured weight pruning and weight unification, according to still other embodiments.

FIG. 5 is a flowchart of a method of neural network model compression with micro-structured weight pruning and weight unification, according to embodiments.

FIG. 6 is a block diagram of an apparatus for neural network model compression with micro-structured weight pruning and weight unification, according to embodiments.

### DETAILED DESCRIPTION

This disclosure is related to neural network model compression. To be more specific, methods and apparatuses described herein are related to neural network model compression with micro-structured weight pruning and weight unification.

Embodiments described herein include a method and an apparatus for compressing a DNN model by using a micro-structured weight pruning regularization in an iterative network retraining/finetuning framework. A pruning loss is jointly optimized with the original network training target through the iterative retraining/finetuning process.

The embodiments described herein further include a method and an apparatus for compressing a DNN model by using a structured unification regularization in an iterative network retraining/finetuning framework. A weight unification loss includes a compression rate loss, a unification distortion loss, and a computation speed loss. The weight unification loss is jointly optimized with the original network training target through the iterative retraining/finetuning process.

The embodiments described herein further include a method and an apparatus for compressing a DNN model by using a micro-structured joint weight pruning and weight unification regularization in an iterative network retraining/finetuning framework. A pruning loss and a unification loss are jointly optimized with the original network training target through the iterative retraining/finetuning process.

There exist several approaches for learning a compact DNN model. The target is to remove unimportant weight coefficients and the assumption is that the smaller the weight coefficients are in value, the less important they are, and the less impact there is on the prediction performance by removing these weights. Several network pruning methods have been proposed to pursue this goal. For example, the unstructured weight pruning methods adds sparsity-promoting regularization terms into the network training target and obtain unstructurally distributed zero-valued weights, which can reduce model size but can not reduce inference time. The structured weight pruning methods deliberately enforce entire weight structures to be pruned, such as rows or columns. The removed rows or columns will not participate in the inference computation and both the model size and inference time can be reduced. However, removing entire weight structures like rows and columns may cause large performance drop of the original DNN model.

Several network pruning methods add sparsity-promoting regularization terms into the network training target. Unstructured weight pruning methods add sparsity-promoting regularization terms into the network training target and obtain unstructurally distributed zero-valued weights. The structured weight pruning methods deliberately enforce selected weight structures to be pruned, such as rows or columns. From the perspective of compressing DNN models, after learning a compact network model, the weight coefficients can be further compressed by quantization followed by entropy coding. Such further compression processes can significantly reduce the storage size of the DNN model, which are used for model deployment over mobile devices, chips, etc.

Embodiments described herein include a method and an apparatus for micro-structured weight pruning aiming at reducing the model size as well as accelerating inference computation, with little sacrifice of the prediction performance of the original DNN model. An iterative network retraining/refining framework is used to jointly optimize the original training target and the weight pruning loss. Weight coefficients are pruned according to small micro-structures that align with the underlying hardware design, so that the model size can be largely reduced, the original target prediction performance can be largely preserved, and the inference computation can be largely accelerated. The method and the apparatus can be applied to compress an original pretrained dense DNN model. They can also be used as an additional processing module to further compress a pre-pruned sparse DNN model by other unstructured or structured pruning approaches.

The embodiments described herein further include a method and an apparatus for a structured weight unification regularization aiming at improving the compression efficiency in later compression process. An iterative network retraining/refining framework is used to jointly optimize the original training target and the weight unification loss including the compression rate loss, the unification distortion loss, and the computation speed loss, so that the learned network weight coefficients preserves the original target performance, are suitable for further compression, and can speed up computation of using the learned weight coefficients. The method and the apparatus can be applied to compress the original pretrained DNN model. They can also be used as an additional processing module to further compress any pruned DNN model.

The embodiments described herein include a method and an apparatus for a joint micro-structured weight pruning and weight unification aiming at improving the compression efficiency in later compression process as well as accelerating inference computation. An iterative network retraining/refining framework is used to jointly optimize the original training target and the weight pruning loss and weight unification loss. Weight coefficients are pruned or unified according to small micro-structures, and the learned weight coefficients preserve the original target performance, are suitable for further compression, and can speed up computation of using the learned weight coefficients. The method and the apparatus can be applied to compress an original pretrained dense DNN model. They can also be used as an additional processing module to further compress a pre-pruned sparse DNN model by other unstructured or structured pruning approaches.

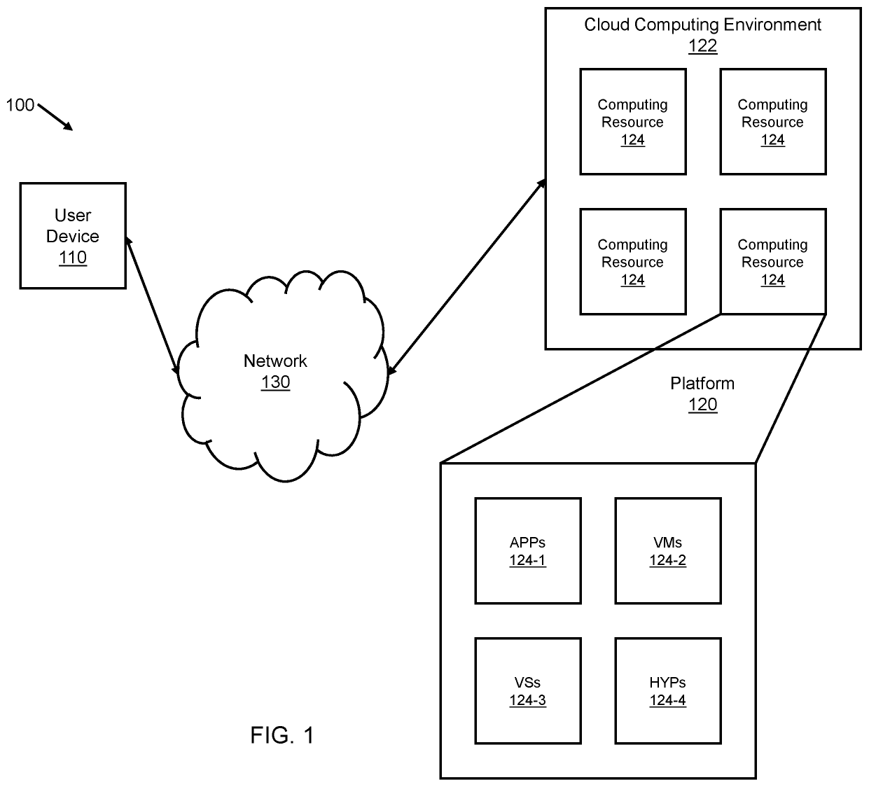

FIG. 1 is a diagram of an environment 100 in which methods, apparatuses and systems described herein may be implemented, according to embodiments.

As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g., the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g., a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g., the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g., “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment 100 may perform one or more functions described as being performed by another set of devices of the environment 100.

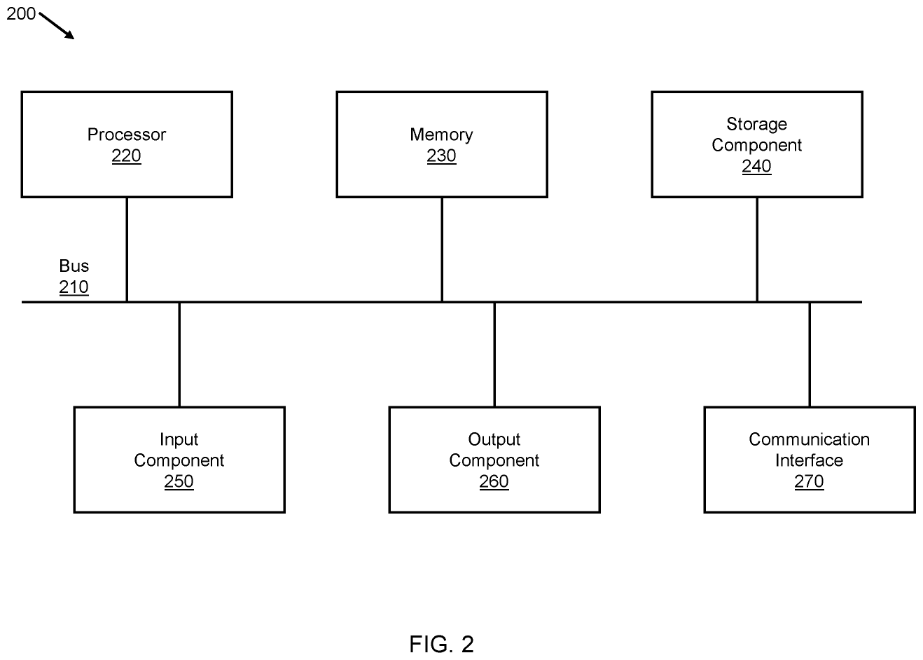

FIG. 2 is a block diagram of example components of one or more devices of FIG. 1.

A device 200 may correspond to the user device 110 and/or the platform 120. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g., a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g., a touch screen display, a keyboard, a keypad, a mouse, a button, a switch, and/or a microphone). Additionally, or alternatively, the input component 250 may include a sensor for sensing information (e.g., a global positioning system (GPS) component, an accelerometer, a gyroscope, and/or an actuator). The output component 260 includes a component that provides output information from the device 200 (e.g., a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g., one or more components) of the device 200 may perform one or more functions described as being performed by another set of components of the device 200.

Methods and apparatuses for neural network model compression with micro-structured weight pruning and weight unification will now be described in detail.

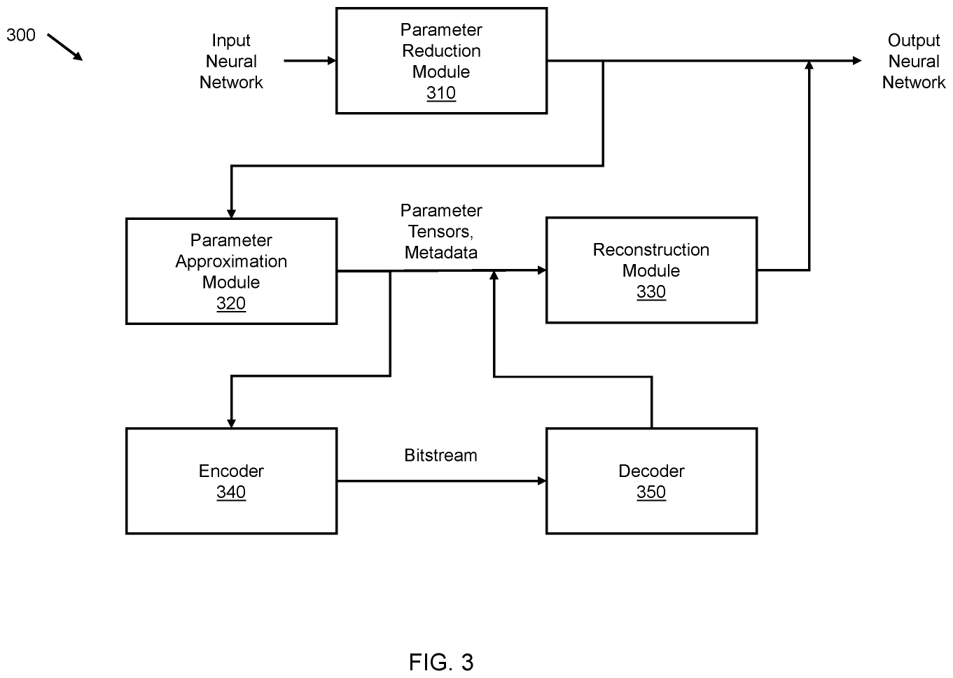

FIG. 3 is a functional block diagram of a system 300 for neural network model compression, according to embodiments.

As shown in FIG. 3, the system 300 includes a parameter reduction module 310, a parameter approximation module 320, a reconstruction module 330, an encoder 340, and a decoder 350.

The parameter reduction module 310 reduces a set of parameters of an input neural network, to obtain an output neural network. The neural network may include the parameters and an architecture as specified by a deep learning framework.

For example, the parameter reduction module 310 may sparsify (set weights to zero) and/or prune away connections of the neural network. In another example, the parameter reduction module 310 may perform matrix decomposition on parameter tensors of the neural network into a set of smaller parameter tensors. The parameter reduction module 310 may perform these methods in cascade, for example, may first sparsify the weights and then decompose a resulting matrix.

The parameter approximation module 320 applies parameter approximation techniques on parameter tensors that are extracted from the output neural network that is obtained from the parameter reduction module 310. For example, the techniques may include any one or any combination of quantization, transformation and prediction. The parameter approximation module 320 outputs first parameter tensors that are not modified by the parameter approximation module 320, second parameter tensors that are modified or approximated by the parameter approximation module 320, and respective metadata to be used to reconstruct original parameter tensors that are not modified by the parameter approximation module 320, from the modified second parameter tensors.

The reconstruction module 330 reconstructs the original parameter tensors from the modified second parameter tensors that are obtained from the parameter approximation module 320 and/or the decoder 350, using the respective metadata that is obtained from the parameter approximation module 320 and/or the decoder 350. The reconstruction module 330 may reconstruct the output neural network, using the reconstructed original parameter tensors and the first parameter tensors.

The encoder 340 may perform entropy encoding on the first parameter tensors, the second parameter tensors and the respective metadata that are obtained from the parameter approximation module 320. This information may be encoded into a bitstream to the decoder 350.

The decoder 350 may decode the bitstream that is obtained from the encoder 340, to obtain the first parameter tensors, the second parameter tensors and the respective metadata.

The system 300 may be implemented in the platform 120, and one or more modules of FIG. 3 may be performed by a device or a group of devices separate from or including the platform 120, such as the user device 110.

The parameter reduction module 310 or the parameter approximation module 320 may include a DNN that is trained by the following training apparatuses.

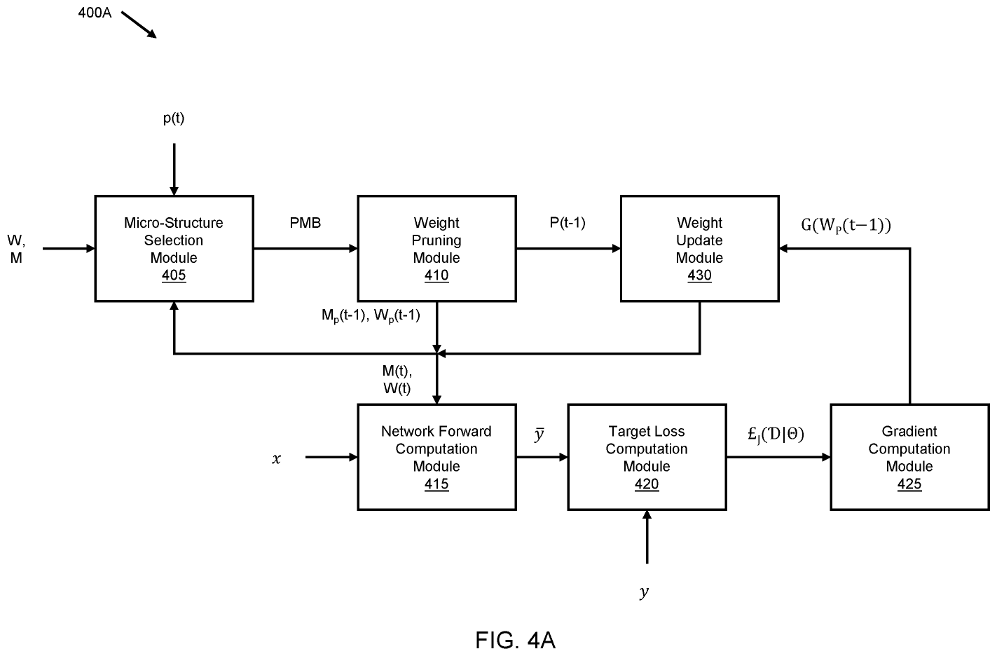

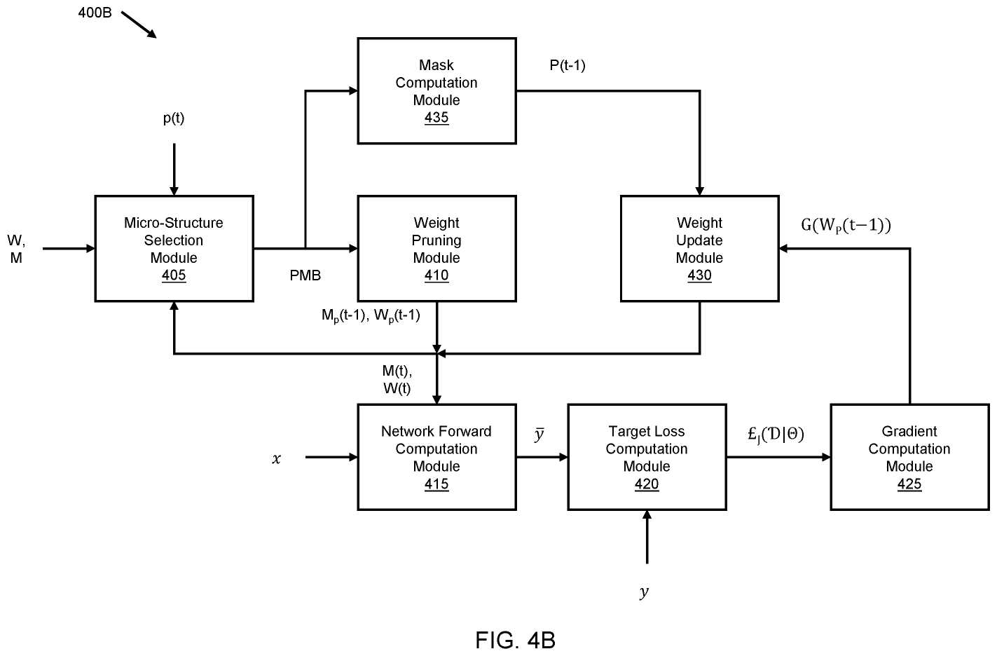

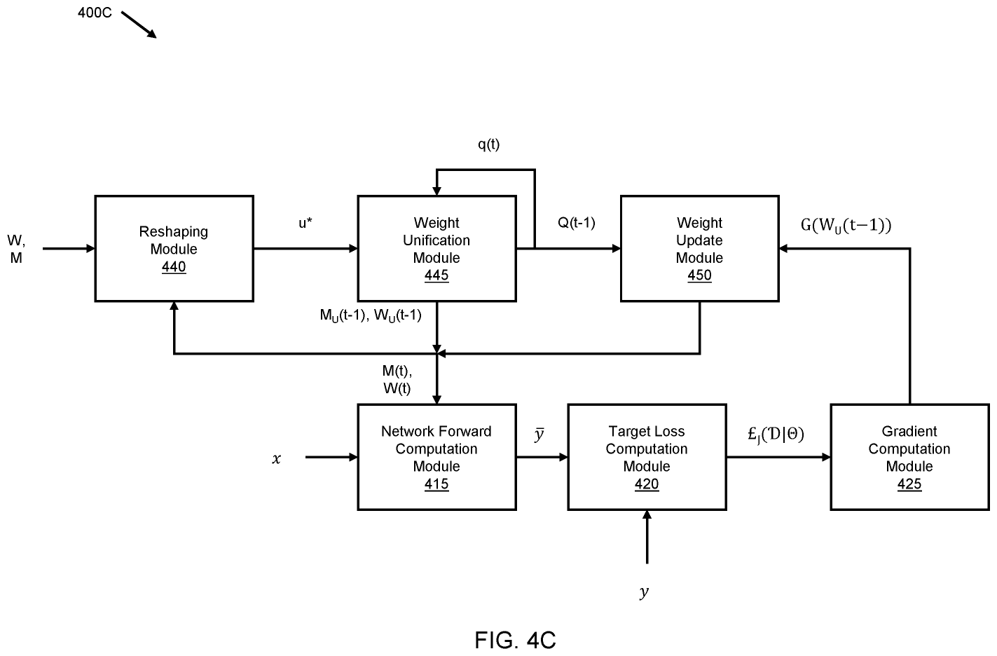

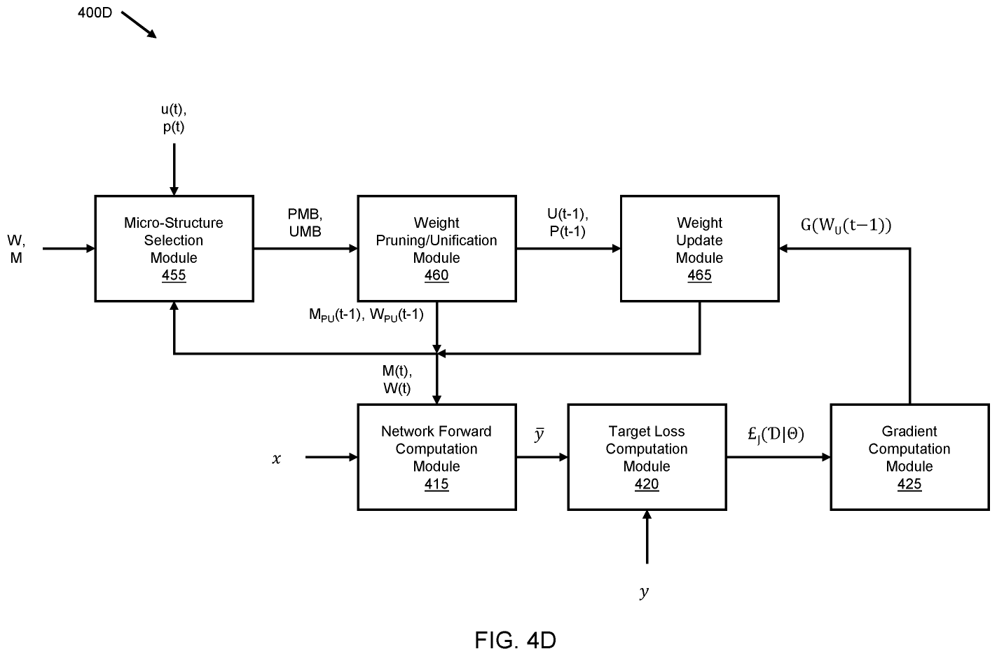

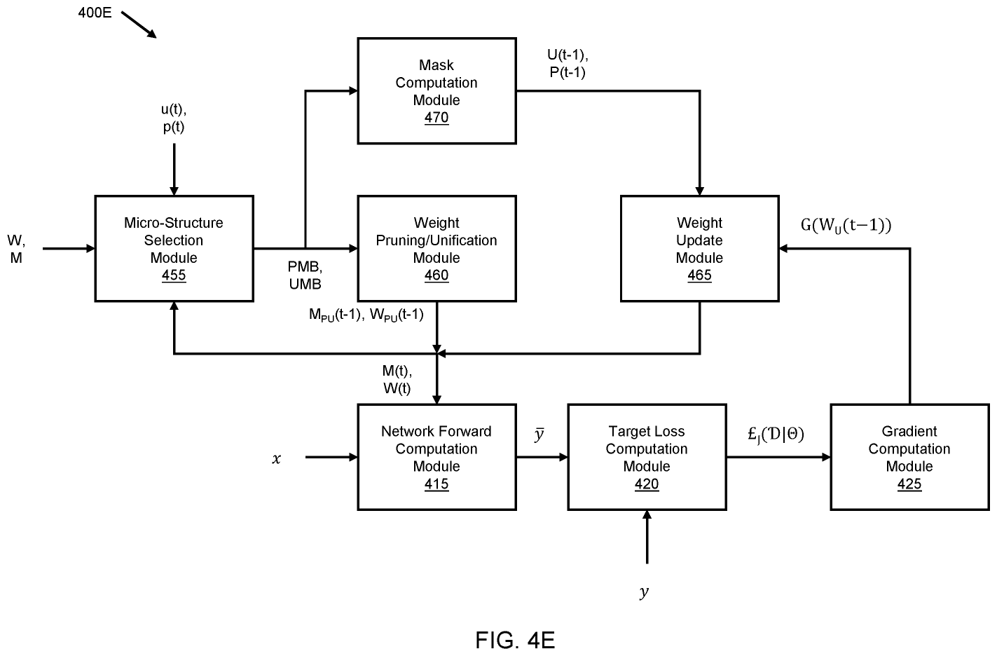

FIG. 4A is a functional block diagram of a training apparatus 400A for neural network model compression with micro-structured weight pruning, according to embodiments. FIG. 4B is a functional block diagram of a training apparatus 400B for neural network model compression with micro-structured weight pruning, according to other embodiments.

As shown in FIG. 4A, the training apparatus 400A includes a micro-structure selection module 405, a weight pruning module 410, a network forward computation module 415, a target loss computation module 420, a gradient computation module 425 and a weight update module 430.

As shown in FIG. 4B, the training apparatus 400B includes the micro-structure selection module 405, the weight pruning module 410, the network forward computation module 415, the target loss computation module 420, the gradient computation module 425 and the weight update module 430. The training apparatus 400B further includes a mask computation module 435.

Let [symbol] ={(x,y)} denote a data set in which a target y is assigned to an input x. Let Θ={w} denote a set of weight coefficients of a DNN (e.g., of the parameter reduction module 310 or the parameter approximation module 320). The target of network training is to learn an optimal set of weight coefficients Θ so that a target loss £( [symbol] |Θ) can be minimized. For example, in previous network pruning approaches, the target loss £_{T}( [symbol] |Θ) has two parts, an empirical data loss [symbol] ( [symbol] |Θ) and a sparsity-promoting regularization loss £_{R}(Θ):

£_{T}( [symbol] |Θ)= [symbol] ( [symbol] |Θ)+λ_{R}£_{R}(Θ), (1)

where λ_{R}≥0 is a hyperparameter balancing the contributions of the data loss and the regularization loss. When λ_{R}=0, only the target loss £_{T}( [symbol] |Θ) only considers the empirical data loss, and the pre-trained weight coefficients are dense.

The pre-trained weight coefficients Θ can further go through another network training process in which an optimal set of weight coefficients can be learned achieve further model compression and inference acceleration. Embodiments include a micro-structured pruning method to achieve this goal.

Specifically, a micro-structured weight pruning loss £_{S}( [symbol] |Θ) is defined, which is optimized together with the original target loss:

£( [symbol] |Θ)=£_{T}( [symbol] |Θ)+λ_{S}£_{S}(Θ), (2)

where λ_{S}≥0 is a hyperparameter to balance the contributions of the original training target and the weight pruning target. By optimizing £( [symbol] |Θ) of Equation (2), the optimal set of weight coefficients that can largely help the effectiveness of further compression can be obtained. Also, the micro-structured weight pruning loss takes into consideration the underlying process of how the convolution operation is performed as a GEMM matrix multiplication process, resulting in optimized weight coefficients that can largely accelerate computation. It is worth noting that the weight pruning loss can be viewed as an additional regularization term to a target loss, with (when λ_{R}>0) or without (when λ_{R}=0) regularizations. Also, the method can be flexibly applied to any regularization loss £_{R}(Θ).

For both the learning effectiveness and the learning efficiency, an iterative optimization process is performed. In the first step, parts of the weight coefficients satisfying the desired micro structure are fixed, and then in the second step, the non-fixed parts of the weight coefficients are updated by back-propagating the training loss. By iteratively conducting these two steps, more and more weights can be fixed gradually, and the joint loss can be gradually optimized effectively.

Moreover, in embodiments, each layer is compressed individually, and so £_{S}( [symbol] |Θ) can be further written as:

£_{S}(Θ)=Σⱼ₌₁^{N}L_{S}(W^{j}), (3)

where L_{S}(W^{j}) is a pruning loss defined over the j-th layer, N is the total number of layers that are involved in this training process, and W^{j} denotes the weight coefficients of the j-th layer. Again, since L_{S}(W^{j}) is computed for each layer independently, the script j may be omitted without loss of generality.

For each network layer, its weight coefficients W is a 5-Dimension (5D) tensor with size (cᵢ, k₁, k₂, k₃, cₒ). The input of the layer is a 4-Dimension (4D) tensor A of size (hᵢ,wᵢ,dᵢ,cᵢ), and the output of the layer is a 4D tensor B of size (hₒ,wₒ,dₒ,cₒ). The sizes cᵢ, k₁, k₂, k₃, cₒ, wᵢ, dᵢ, hₒ, wₒ, dₒ are integer numbers greater or equal to 1. When any of the sizes cᵢ, k₁, k₂, k₃, cₒ, hᵢ, wᵢ, dᵢ, hₒ, wₒ, dₒ takes number 1, the corresponding tensor reduces to a lower dimension. Each item in each tensor is a floating number. Let M denote a 5D binary mask of the same size as W, where each item in M is a binary number 0/1 indicating whether the corresponding weight coefficient is pruned/kept in a pre-pruned process. M is introduced to be associated with W to cope with the case in which W is from a pruned DNN model using previous structured or unstructured pruning methods, where some connections between neurons in the network are removed from computation. When W is from the original unpruned dense model, all items in M take value 1. The output B is computed through the convolution operation ⊙ based on A, M and W:

$${B}_{{l}^{′} , {m}^{′} , {n}^{′} , v} = {\sum }_{r = 1}^{{k}_{1}} {\sum }_{s = 1}^{{k}_{2}} {\sum }_{t}^{{k}_{3}} {\sum }_{u = 1}^{{c}_{i}} {M}_{u , r , s , t , v} {W}_{u , r , s , t , v} {A}_{u , l - \frac{{k}_{1} - 1}{2} + r , m - \frac{{k}_{2} - 1}{2} + s , n - \frac{{k}_{3} - 1}{2} + t} , \\ l = 1 , . . . , {h}_{i} , m = 1 , . . . , {w}_{i} , n = 1 , . . . , {d}_{i} , {l}^{′} = 1 , . . . , {h}_{o} , \\ {m}^{′} = 1 , . . . , {w}_{o} , {n}^{′} = 1 , . . . , {d}_{o} , v = 1 , . . . , {c}_{o} . \qquad ( 4 )$$

The parameters hᵢ, wᵢ and dᵢ (h₀, wₒ and dₒ) are the height, weight and depth of the input tensor A (output tensor B). The parameter cᵢ (cₒ) is the number of input (output) channel. The parameters k₁, k₂ and k₃ are the size of the convolution kernel corresponding to the height, weight and depth axes, respectively. That is, for each output channel v=1, . . . , cₒ, the operation described in Equation (4) can be seen as a 4D weight tensor Wᵥ of size (cᵢ,k₁,k₂,k₃) convolving with the input A.

The order of the summation operation in Equation (4) can be changed, resulting in different configurations of the shapes of input A, weight W (and mask M) to obtain the same output B. In embodiments, two configurations are taken. (1) The 5D weight tensor is reshaped into a 3D tensor of size (c′ᵢ, c′ₒ, k), where c′ᵢ×c′ₒ×k=cᵢ×cₒ×k₁×k₂×k₃. For example, a configuration is c′ᵢ=cᵢ, c′ₒ=cₒ, k=k₁×k₂×k₃. (2) The 5D weight tensor is reshaped into a 2D matrix of size (c′ᵢ, c′ₒ), where c′ᵢ×c′ₒ=cᵢ×cₒ×k₁×k₂×k₃. For example, some embodiments are c′ᵢ=cᵢ, c′ₒ=cₒ×k₁×k₂×k₃, or c′ᵢ=cₒ, c′ᵢ=cᵢ×k₁×k₂×k₃.

The desired micro-structure of the weight coefficients is aligned with the underlying GEMM matrix multiplication process of how the convolution operation is implemented so that the inference computation of using the learned weight coefficients is accelerated. In embodiments, block-wise micro-structures for the weight coefficients are used in each layer in the 3D reshaped weight tensor or the 2D reshaped weight matrix. Specifically, for the case of reshaped 3D weight tensor, it is partitioned into blocks of size (gᵢ,gₒ,gₖ), and for the case of reshaped 2D weight matrix, it is partitioned into blocks of size (gᵢ,gₒ). The pruning operation happens within the 2D or 3D blocks, i.e., pruned weights in a block are set to be all zeros. A pruning loss of the block can be computed measuring the error introduced by such a pruning operation. Given this micro-structure, during an iteration, the part of the weight coefficients to be pruned is determined based on the pruning loss. Then, in the second step, the pruned weights are fixed, and the normal neural network training process is performed and the remaining un-fixed weight coefficients are updated through the back-propagation mechanism.

FIGS. 4A and 4B show embodiments of the iterative retraining/finetuning process, both iteratively alternate two steps to optimize the joint loss of Equation (2) gradually. Given a pre-trained DNN model with weight coefficients {W} and mask {M}, which can be either a pruned sparse model or an un-pruned non-sparse model, in the first step, the micro-structure selection module 405 first reshapes the weight coefficients W (and the corresponding mask M) of each layer into the desired 3D tensor or 2D matrix. Then for each layer, the micro-structure selection module 405 determines a set of pruning micro-structures {bₛ} or pruning micro-structure blocks (PMB) whose weights will be pruned through a Pruning Micro-Structure Selection process. There are multiple ways to determine the pruning micro-structures {bₛ}. In embodiments, for each layer with weight coefficient W and mask M, for each block b in W, the pruning loss Lₛ(b) (e.g., the summation of the absolute of weights in b) is computed. Given a pruning ratio p, the blocks of this layer are ranked according to Lₛ(b) in accenting order, and the top p % blocks are selected as {bₛ} to be pruned. In other embodiments, for each layer with weight coefficient W and mask M, the pruning loss Lₛ(b) of each block b is computed in the same way as above. Given a pruning ratio p, all the blocks of all the layers are ranked according to Lₛ(b) in accenting order, and the top p % blocks are selected as {bₛ} to be pruned.

After obtaining the set of pruning micro-structure, the target turns to finding a set of updated optimal weight coefficients W* and the corresponding weight mask M* by iteratively minimizing the joint loss described in Equation (2). In the first embodiment illustrated by FIG. 4A, for the t-th iteration, there are the current weight coefficients W(t−1). Also, a micro-structurally pruning mask P(t−1) is maintained throughout the training process. P(t−1) has the same shape as W(t−1), recording whether a corresponding weight coefficient is pruned or not. Then, the weight pruning module 410 computes a pruned weight coefficients W_{P}(t−1) through a Weight Pruning process, in which selected pruning micro-structures masked by P(t−1) are pruned, resulting in an updated weight mask M_{P}(t−1).

Then in the second step, the weight update module 430 fixes the weight coefficients that are marked by P(t−1) as being micro-structurally pruned, and then updates the remaining unfixed weight coefficients of W_{P}(t−1) through a neural network training process, resulting in updated W(t) and M(t). In embodiments, the pre-pruned weight coefficients masked by the pre-trained pruning mask M is forced to be fixed during this network training process (i.e., to stay as zero). In another embodiment, no such restriction is placed on the pre-pruned weights, and a pre-pruned weight can be reset to some value other than zero during the training process, resulting in a less sparse model associated with better prediction performance, possibly even better than the original pretrained model.

Specifically, let [symbol] ={(x,y)} denote a training dataset, where [symbol] can be the same as the original dataset [symbol] ₀={(x₀,y₀)} based on which the pre-trained weight coefficients W are obtained. [symbol] can also be a different dataset from [symbol] ₀, but with the same data distribution as the original dataset [symbol] . In the second step, the network forward computation module 415 passes each input x though the current network via a Network Forward Computation process using the current weight coefficients W_{P}(t−1) and mask M_{P}(t−1), which generates an estimated output y̅. Based on the ground-truth annotation y and the estimated output y̅, the target loss computation module 420 computes the target training loss £_{T}( [symbol] |Θ) in Equation (2) through a Compute Target Loss process. Then, the gradient computation module 425 computes the gradient of the target loss G(W_{P}(t−1)). The automatic gradient computing method used by deep learning frameworks such as tensorflow or pytorch can be used to compute G(W_{P}(t−1)). Based on the gradient G(W_{P}(t−1)) and the micro-structurally pruning mask P(t−1), the weight update module 430 can update the non-fixed weight coefficients of W_{P}(t−1) through back-propagation using a Back Propagation and Weight Update process. The retraining process is also an iterative process itself. Multiple iterations are taken to update the non-fixed parts of W_{P}(t−1), e.g., until the target loss converges. Then the system goes to the next iteration t, where given a new pruning ratio p(t), a new set of pruning micro-structures (as well as the new micro-structurally pruning mask P(t)) are determined through the Pruning Micro-Structure Selection process.

In the second embodiment of the training process illustrated by FIG. 4B, the set of updated optimal weight coefficients W* and the corresponding weight mask M* are found by another iterative process. For the t-th iteration, there are the current weight coefficients W(t−1) and mask M(t−1). Also, the mask computation module 435 computes a micro-structurally pruning mask P(t−1) through a Pruning Mask Computation process. P(t−1) has the same shape as W(t−1), recording whether a corresponding weight coefficient is pruned. Then, the weight pruning module 410 computes a pruned weight coefficients W_{P}(t−1) through a Weight Pruning process, in which the selected pruning micro-structures masked are pruned by P(t−1), resulting an updated weight mask M_{P}(t−1).

Then in the second step, the weight update module 430 fixes the weight coefficients that are marked by P(t−1) as being micro-structurally pruned, and then updates the remaining unfixed weight coefficients of W(t−1) through a neural network training process, resulting in updated W(t). Similar to the first embodiment of FIG. 4A, given training dataset [symbol] ={(x,y)}, the network forward computation module 415 passes each input x through the current network via a Network Forward Computation process using the current weight coefficients W(t−1) and mask M(t−1), which generates an estimated output y̅. Based on the ground-truth annotation y and the estimated output y̅, the target loss computation module 420 computes a joint training loss £_{J}( [symbol] |Θ) including the target training loss £_{T}( [symbol] |Θ) in Equation (2) and a residue loss £ᵣₑₛ(W(t−1)) through a Compute Joint Loss process:

£_{J}( [symbol] |Θ)=£_{T}( [symbol] |Θ)+λᵣₑₛ£ᵣₑₛ(W(t−1)). (5)

£ᵣₑₛ(W(t−1)) measures the difference between the current weights W(t−1) and the target pruned weights W_{P}(t−1). For example, the L₁ norm can be used:

£ᵣₑₛ(W(t−1))=∥W(t−1−))−W_{P}(t−1)∥ (6)

Then, the gradient computation module 425 computes the gradient of the joint loss G(W(t−1)). The automatic gradient computing method used by deep learning frameworks such as tensorflow or pytorch can be used to compute G(W(t−1)). Based on the gradient G(W(t−1)) and the micro-structurally pruning mask P(t−1), the weight update module 430 updates the non-fixed weight coefficients of W(t−1) through back-propagation using a Back Propagation and Weight Update process. The retraining process is also an iterative process itself. Multiple iterations are taken to update the non-fixed parts of W(t−1), e.g., until the target loss converges. Then the system goes to the next iteration t, where given a pruning ratio p(t), a new set of pruning micro-structures (as well as the new micro-structurally pruning mask P(t)) are determined through the Pruning Micro-Structure Selection process. Similar to the previous embodiment of FIG. 4A, during this training process, the weight coefficients masked by the pretrained pre-pruning mask M can be enforced to stay zero, or may be set to have a non-zero value again.

During this whole iterative process, at a T-th iteration, a pruned weight coefficients W_{P}(T) can be computed through the Weight Pruning process, in which the selected pruning micro-structures masked are pruned by P(T), resulting an updated weight mask M_{P}(T). This W_{P}(T) and M_{P}(T) can be used to generate the final updated model W* and M*. For example, W*=W_{P}(T), and M*=M·M_{P}(T).

In embodiments, the hyperparameter p(t) may increase its value during iterations as t increases, so that more and more weight coefficients will be pruned and fixed throughout the entire iterative learning process.

The micro-structured pruning method targets reducing the model size, speeding up computation for using the optimized weight coefficients, and preserving the prediction performance of the original DNN model. It can be applied to a pre-trained dense model, or a pre-trained sparse model pruned by previous structured or unstructured pruning methods, to achieve additional compression effects.

Through the iterative retraining process, the method can effectively maintain the performance of the original prediction target and pursue compression and computation efficiency. The iterative retraining process also gives the flexibility of introducing different loss at different times, making the system focus on different target during the optimization process.

The method can be applied to datasets with different data forms. The input/output data are 4D tensors, which can be real video segments, images, or extracted feature maps.

FIG. 4C is a functional block diagram of a training apparatus 400C for neural network model compression with weight unification, according to still other embodiments.

As shown in FIG. 4C, the training apparatus 400C includes a reshaping module 440, a weight unification module 445, the network forward computation module 415, the target loss computation module 420, the gradient computation module 425 and a weight update module 450.

The sparsity-promoting regularization loss places regularization over the entire weight coefficients, and the resulting sparse weights have weak relationship with the inference efficiency or computation acceleration. From another perspective, after pruning, the sparse weights can further go through another network training process in which an optimal set of weight coefficients can be learned that can improve the efficiency of further model compression.

A weight unification loss £_{U}( [symbol] |Θ) is optimized together with the original target loss:

£( [symbol] |Θ)=£_{T}( [symbol] |Θ)+λ_{U}£_{U}(Θ), (7)

where λ_{U}≥0 is a hyperparameter to balance the contributions of the original training target and the weight unification. By jointly optimizing £( [symbol] |Θ) of Equation (7), the optimal set of weight coefficients that can largely help the effectiveness of further compression is obtained. Also, the weight unification loss takes into consideration the underlying process of how the convolution operation is performed as a GEMM matrix multiplication process, resulting in optimized weight coefficients that can largely accelerate computation. It is worth noting that the weight unification loss can be viewed as an additional regularization term to a target loss, with (when λ_{R}>0) or without (when λ_{R}=0) regularizations. Also, the method can be flexibly applied to any regularization loss £_{R}(Θ).

In embodiments, the weight unification loss £_{U}(Θ) further includes the compression rate loss £_{C}(Θ), the unification distortion loss £_{I}(Θ), and the computation speed loss £_{S}(Θ):

£_{U}(Θ)=£_{I}(Θ)+λ_{C}£_{C}(Θ)+λ_{S}£_{S}(Θ), (8)

Detailed descriptions of these loss terms are described in later sessions. For both the learning effectiveness and the learning efficiency, an iterative optimization process is performed. In the first step, parts of the weight coefficients satisfying the desired structure are fixed, and then in the second step, the non-fixed parts of the weight coefficients are updated by back-propagating the training loss. By iteratively conducting these two steps, more and more weights can be fixed gradually, and the joint loss can be gradually optimized effectively.

Moreover, in embodiments, each layer is compressed individually, £_{U}( [symbol] |Θ) can be further written as:

£_{U}(Θ)=Σⱼ₌₁^{N}L_{U}(W^{j}), (9)

where L_{U} (W^{j}) is a unification loss defined over the j-th layer; N is the total number of layers where the quantization loss is measured; and W^{j} denotes the weight coefficients of the j-th layer. Again, since L_{U}(W^{j}) is computed for each layer independently, in the rest of the disclosure the script j may be omitted without loss of generality.

For each network layer, its weight coefficients W is a 5-Dimension (5D) tensor with size (cᵢ, k₁, k₂, k₃, cₒ). The input of the layer is a 4-Dimension (4D) tensor A of size (hᵢ,wᵢ,dᵢ,cᵢ), and the output of the layer is a 4D tensor B of size (hₒ,wₒ,dₒ,cₒ). The sizes cᵢ, k₁, k₂, k₃, cₒ, hᵢ, wᵢ, hₒ, wₒ, dₒ are integer numbers greater or equal to 1. When any of the sizes cᵢ, k₁, k₂, k₃, cₒ, hᵢ, wᵢ, dᵢ, hₒ, wₒ, dₒ takes number 1, the corresponding tensor reduces to a lower dimension. Each item in each tensor is a floating number. Let M denote a 5D binary mask of the same size as W, where each item in M is a binary number 0/1 indicating whether the corresponding weight coefficient is pruned/kept. M is introduced to be associated with W to cope with the case in which W is from a pruned DNN model in which some connections between neurons in the network are removed from computation. When W is from the original unpruned pretrained model, all items in M take value 1. The output B is computed through the convolution operation ⊙ based on A, M and W:

$${B}_{{l}^{′} , {m}^{′} , {n}^{′} , v} = {\sum }_{r = 1}^{{k}_{1}} {\sum }_{s = 1}^{{k}_{2}} {\sum }_{t}^{{k}_{3}} {\sum }_{u = 1}^{{c}_{i}} {M}_{u , r , s , t , v} {W}_{u , r , s , t , v} {A}_{u , l - \frac{{k}_{1} - 1}{2} + r , m - \frac{{k}_{2} - 1}{2} + s , n - \frac{{k}_{3} - 1}{2} + t} , \\ l = 1 , . . . , {h}_{i} , m = 1 , . . . , {w}_{i} , n = 1 , . . . , {d}_{i} , {l}^{′} = 1 , . . . , {h}_{o} , \\ {m}^{′} = 1 , . . . , {w}_{o} , {n}^{′} = 1 , . . . , {d}_{o} , v = 1 , . . . , {c}_{o} . \qquad ( 10 )$$

The parameters hᵢ, wᵢ and dᵢ (h₀, wₒ and dₒ) are the height, weight and depth of the input tensor A (output tensor B). The parameter cᵢ (cₒ) is the number of input (output) channel. The parameters k₁, k₂ and k₃ are the size of the convolution kernel corresponding to the height, weight and depth axes, respectively. That is, for each output channel v=1, . . . , cₒ, the operation described in Equation (10) can be seen as a 4D weight tensor Wᵥ of size (cᵢ,k₁,k₂,k₃) convolving with the input A.

The order of the summation operation in Equation (10) can be changed, and in embodiments, the operation of Equation (10) is performed as follows. The 5D weight tensor is reshaped into a 2D matrix of size (c′ᵢ, c′ₒ) where c′ᵢ×c′ₒ=cᵢ×cₒ×k₁×k₂×k₃. For example, some embodiments are c′ᵢ=cᵢ, c′ₒ=cₒ×k₁×k₂×k₃, or c′ₒ=cₒ, c′ᵢ=cᵢ×k₁×k₂×k₃.

The desired structure of the weight coefficients is designed by taking into consideration two aspects. First, the structure of the weight coefficients is aligned with the underlying GEMM matrix multiplication process of how the convolution operation is implemented so that the inference computation of using the learned weight coefficients is accelerated. Second, the structure of the weight coefficients can help to improve the quantization and entropy coding efficiency for further compression. In embodiments, a block-wise structure for the weight coefficients is used in each layer in the 2D reshaped weight matrix. Specifically, the 2D matrix is partitioned into blocks of size (gᵢ,gₒ), and all coefficients within the block are unified. Unified weights in a block are set to follow a pre-defined unification rule, e.g., all values are set to be the same so that one value can be used to represent the whole block in the quantization process that yields high efficiency. There can be multiple rules of unifying weights, each associated with a unification distortion loss measuring the error introduced by taking this rule. For example, instead of setting the weights to be the same, the weights are set to have the same absolute value while keeping their original signs. Given this designed structure, during an iteration, the part of the weight coefficients is determined to be fixed by taking into consideration the unification distortion loss, the estimated compression rate loss, and the estimated speed loss. Then, in the second step, the normal neural network training process is performed and the remaining un-fixed weight coefficients are updated through the back-propagation mechanism.

FIG. 4C shows the overall framework of the iterative retraining/finetuning process, which iteratively alternates two steps to optimize the joint loss of Equation (7) gradually. Given a pre-trained DNN model with weight coefficients W and mask M, which can be either a pruned sparse model or an un-pruned non-sparse model, in the first step, the reshaping module 440 determines the weight unifying methods u* through a Unification Method Selection process. In this process, the reshaping module 440 reshapes the weight coefficients W (and the corresponding mask M) into a 2D matrix of size (c′ᵢ, c′ₒ), ca and then partitions the reshaped 2D weight matrix W into blocks of size (gᵢ,gₒ). Weight unification happens inside the blocks. For each block b, a weight unifier is used to unify weight coefficients within the block. There can be different ways to unify weight coefficients in b. For example, the weight unifier can set all weights in b to be the same, e.g., the mean of all weights in b. In such a case, the L_{N} norm of the weight coefficients in b (e.g., L₂ norm as variance of weights in b) reflects the unification distortion loss £_{I}(b) of using the mean to represent the entire block. Also, the weight unifier can set all weights to have the same absolute value, while keeping the original signs. In such a case, the L_{N} norm of the absolute of weights in b can be used to measure L_{I}(b). In other words, given a weight unifying method u, the weight unifier can unify weights in b using the method u with an associated unification distortion loss L_{I}(u,b).

Similarly, the compression rate loss £_{C}(u,b) of Equation (8) reflects the compression efficiency of unifying weights in b using method u. For example, when all weights are set to be the same, only one number is used to represent the whole block, and the compression rate is r_{compression}=gᵢ·gₒ. £_{C}(u,b) can be defined as 1/r_{compression}.

The speed loss £_{S}(u,b) in Equation (8) reflects the estimated computation speed of using the unified weight coefficients in b with method u, which is a function of the number of multiplication operation in computation using the unified weight coefficients.

By now, and for each possible method u of unifying weights in b by the weight unifier, the weight unification loss £_{U}(u,b) of Equation (8) is computed based on £_{I}(u,b), £_{C}(u,b), £_{S}(u,b). The optimal weight unifying method u* can be selected with the smallest weight unification loss £_{U}*(u,b).

Once the weight unifying method u* is determined for every block b, the target turns to finding a set of updated optimal weight coefficients W* and the corresponding weight mask M* by iteratively minimizing the joint loss described in Equation (7). Specifically, for the t-th iteration, there are the current weight coefficients W(t−1) and mask M(t−1). Also, a weight unifying mask Q(t−1) is maintained throughout the training process. The weight unifying mask Q(t−1) has the same shape as W(t−1), which records whether a corresponding weight coefficient is unified or not. Then, the weight unification module 445 computes unified weight coefficients W_{U}(t−1) and a new unifying mask Q(t−1) through a Weight Unification process. In the Weight Unification process, the blocks are ranked based on their unification loss £_{U}(u*,b) in accenting order. Given a hyperparameter q, the top q % blocks are selected to be unified. And the weight unifier unifies the blocks in the selected blocks b using the corresponding determined method u*, resulting in a unified weight W_{U}(t−1) and weight mask M_{U}(t−1). The corresponding entry in the unifying mask Q(t−1) is marked as being unified. In embodiments, M_{U}(t−1) is different from M(t−1), in which for a block having both pruned and unpruned weight coefficients, the originally pruned weight coefficients will be set to have a non-zero value again by the weight unifier, and the corresponding item in M_{U}(t−1) will be changed. In another embodiment, M_{U}(t−1) is the same with M(t−1), in which for the blocks having both pruned and unpruned weight coefficients, only the unpruned weights will be reset, while the pruned weights remain to be zero.

Then in the second step, the weight update module 450 fixes the weight coefficients that are marked in Q(t−1) as being unified, and then updates the remaining unfixed weight coefficients of W(t−1) through a neural network training process, resulting in updated W(t) and M(t).

Let [symbol] ={(x,y)} denote a training dataset, where [symbol] can be the same as the original dataset [symbol] ₀={(x₀,y₀)} based on which the pre-trained weight coefficients W are obtained. [symbol] can also be a different dataset from [symbol] ₀, but with the same data distribution as the original dataset [symbol] . In the second step, the network forward computation module 415 passes each input x through the current network via a Network Forward Computation process using the current weight coefficients W_{U}(t−1) and mask M_{U}(t−1), which generates an estimated output y̅. Based on the ground-truth annotation y and the estimated output y̅, the target loss computation module 420 computes the target training loss £_{T}( [symbol] |Θ) in Equation (7) through a Compute Target Loss process. Then, the gradient computation module 425 computes the gradient of the target loss G(W_{U}(t−1)). The automatic gradient computing method used by deep learning frameworks such as tensorflow or pytorch can be used to compute G(W_{U}(t−1)). Based on the gradient G(W_{U}(t−1)) and the unifying mask Q(t−1), the weight update module 450 updates the non-fixed weight coefficients of W_{U}(t−1) and the corresponding mask M_{U}(t−1) through back-propagation using a Back Propagation and Weight Update process. The retraining process is also an iterative process itself. Multiple iterations are taken to update the non-fixed parts of W_{U}(t−1) and the corresponding M(t−1), e.g., until the target loss converges. Then the system goes to the next iteration t, in which given a new hyperparameter q(t), based on W_{U}(t−1) and u*, a new unified weight coefficients W_{U}(t), mask M_{U}(t), and the corresponding unifying mask Q(t) can be computed through the Weight Unification process.

In embodiments, the hyperparameter q(t) increases its value during each iteration as t increases, so that more and more weight coefficients will be unified and fixed throughout the entire iterative learning process.

The unification regularization targets improving the efficiency of further compression of the learned weight coefficients, speeding up computation for using the optimized weight coefficients. This can significantly reduce the DNN model size and speedup the inference computation.

Through the iterative retraining process, the method can effectively maintain the performance of the original training target and pursue compression and computation efficiency. The iterative retraining process also gives the flexibility of introducing different loss at different times, making the system focus on different target during the optimization process.

The method can be applied to datasets with different data forms. The input/output data are 4D tensors, which can be real video segments, images, or extracted feature maps.

FIG. 4D is a functional block diagram of a training apparatus 400D for neural network model compression with micro-structured weight pruning and weight unification, according to yet other embodiments. FIG. 4E is a functional block diagram of a training apparatus 400E for neural network model compression with micro-structured weight pruning and weight unification, according to still other embodiments.

As shown in FIG. 4D, the training apparatus 400D includes a micro-structure selection module 455, a weight pruning/unification module 460, the network forward computation module 415, the target loss computation module 420, the gradient computation module 425 and a weight update module 465.

As shown in FIG. 4E, the training apparatus 400E includes the micro-structure selection module 455, the weight pruning/unification module 460, the network forward computation module 415, the target loss computation module 420, the gradient computation module 425 and the weight update module 465. The training apparatus 400E further includes a mask computation module 470.

From another perspective, the pre-trained weight coefficients Θ can further go through another network training process in which an optimal set of weight coefficients can be learned to improve the efficiency of further model compression and inference acceleration. This disclosure describes a micro-structured pruning and unification method to achieve this goal.

Specifically, a micro-structured weight pruning loss £_{S}( [symbol] |Θ) and a micro-structured weight unification loss £_{U}( [symbol] |Θ) are defined, which are optimized together with the original target loss:

£( [symbol] |Θ)=£_{T}( [symbol] |Θ)+λ_{U}£_{U}(Θ)+λ_{S}£_{S}(Θ), (11)

where λ_{S}≥0 and λ_{U}≥0 are hyperparameters to balance the contributions of the original training target, the weight unification target, and the weight pruning target. By jointly optimizing £( [symbol] |Θ) of Equation (11), the optimal set of weight coefficients that can largely help the effectiveness of further compression is obtained. Also, the weight unification loss takes into consideration the underlying process of how the convolution operation is performed as a GEMM matrix multiplication process, resulting in optimized weight coefficients that can largely accelerate computation. It is worth noting that the weight pruning and weight unification loss can be viewed as an additional regularization term to a target loss, with (when λ_{R}>0) or without (when λ_{R}=0) regularizations. Also, the method can be flexibly applied to any regularization loss £_{R}(Θ).

For both the learning effectiveness and the learning efficiency, an iterative optimization process is performed. In the first step, parts of the weight coefficients satisfying the desired structure are fixed, and then in the second step, the non-fixed parts of the weight coefficients are updated by back-propagating the training loss. By iteratively conducting these two steps, more and more weights can be fixed gradually, and the joint loss can be gradually optimized effectively.

Moreover, in embodiments, each layer is compressed individually, and £_{U}( [symbol] |Θ) and £_{S}( [symbol] |Θ) can be further written as:

£_{U}(Θ)=Σⱼ₌₁^{N}L_{U}(W^{j}), £_{S}(Θ)=Σⱼ₌₁^{N}L_{S}(W^{j}), (12)

where L_{U}(W^{j}) is a unification loss defined over the j-th layer; Lₛ(W^{j}) is a pruning loss defined over the j-th layer, N is the total number of layers that are involved in this training process, and IV denotes the weight coefficients of the j-th layer. Again, since L_{U}(W^{j}) and L_{S}(W^{j}) are computed for each layer independently, in the rest of the disclosure the script j is omitted without loss of generality.

For each network layer, its weight coefficients W is a 5-Dmension (5D) tensor with size (cᵢ, k₁, k₂, k₃, cₒ). The input of the layer is a 4-Dimension (4D) tensor A of size (hᵢ,wᵢ,dᵢ,cᵢ), and the output of the layer is a 4D tensor B of size (hₒ,wₒ,dₒ,cₒ). The sizes cᵢ, k₁, k₂, k₃, cₒ, hᵢ, wᵢ, dᵢ, hₒ, wₒ, dₒ are integer numbers greater or equal to 1. When any of the sizes cᵢ, k₁, k₂, k₃, cₒ, hᵢ, wᵢ, dᵢ, hₒ, wₒ, dₒ takes number 1, the corresponding tensor reduces to a lower dimension. Each item in each tensor is a floating number. Let M denote a 5D binary mask of the same size as W, where each item in M is a binary number 0/1 indicating whether the corresponding weight coefficient is pruned/kept in a pre-pruned process. M is introduced to be associated with W to cope with the case in which W is from a pruned DNN model in which some connections between neurons in the network are removed from computation. When W is from the original unpruned dense model, all items in M take value 1. The output B is computed through the convolution operation ⊙ based on A, M and W:

$${B}_{{l}^{′} , {m}^{′} , {n}^{′} , v} = {\sum }_{r = 1}^{{k}_{1}} {\sum }_{s = 1}^{{k}_{2}} {\sum }_{t}^{{k}_{3}} {\sum }_{u = 1}^{{c}_{i}} {M}_{u , r , s , t , v} {W}_{u , r , s , t , v} {A}_{u , l - \frac{{k}_{1} - 1}{2} + r , m - \frac{{k}_{2} - 1}{2} + s , n - \frac{{k}_{3} - 1}{2} + t} , \\ l = 1 , . . . , {h}_{i} , m = 1 , . . . , {w}_{i} , n = 1 , . . . , {d}_{i} , {l}^{′} = 1 , . . . , {h}_{o} , \\ {m}^{′} = 1 , . . . , {w}_{o} , {n}^{′} = 1 , . . . , {d}_{o} , v = 1 , . . . , {c}_{o} . \qquad ( 13 )$$

The parameters hᵢ, wᵢ and dᵢ (h₀, wₒ and dₒ) are the height, weight and depth of the input tensor A (output tensor B). The parameter cᵢ (cₒ) is the number of input (output) channel. The parameters k₁, k₂ and k₃ are the size of the convolution kernel corresponding to the height, weight and depth axes, respectively. That is, for each output channel v=1, . . . , cₒ, the operation described in Equation (13) can be seen as a 4D weight tensor Wᵥ of size (cᵢ,k₁,k₂,k₃) convolving with the input A.

The order of the summation operation in Equation (13) can be changed, resulting in different configurations of the shapes of input A, weight W (and mask M) to obtain the same output B. In embodiments, two configurations are taken. (1) The 5D weight tensor is reshaped into a 3D tensor of size (c′ᵢ, c′ₒ, k), where c′ᵢ×c′ₒ×k=cᵢ×cₒ×k₁×k₂×k₃. For example, a configuration is c′ᵢ=cᵢ, c′ₒ=cₒ, k=k₁×k₂×k₃. (2) The 5D weight tensor is reshaped into a 2D matrix of size (c′ᵢ, c′ₒ), where c′ᵢ×c′ₒ=cᵢ×cₒ×k₁×k₂×k₃. For example, some configurations are c′ᵢ=cᵢ, c′ₒ=cₒ×k₁×k₂×k₃, or c′ₒ=cₒ, c′ᵢ=cᵢ×k₁×k₂×k₃.

The desired micro-structure of the weight coefficients is designed by taking into consideration two aspects. First, the micro-structure of the weight coefficients is aligned with the underlying GEMM matrix multiplication process of how the convolution operation is implemented so that the inference computation of using the learned weight coefficients is accelerated. Second, the micro-structure of the weight coefficients can help to improve the quantization and entropy coding efficiency for further compression. In embodiments, block-wise micro-structures for the weight coefficients are used in each layer in the 3D reshaped weight tensor or the 2D reshaped weight matrix. Specifically, for the case of reshaped 3D weight tensor, it is partitioned into blocks of size (gᵢ,gₒ,gₖ), and all coefficients within the block are pruned or unified. For the case of reshaped 2D weight matrix, it is partitioned into blocks of size (gᵢ,gₒ), and all coefficients within the block are pruned or unified. Pruned weights in a block are set to be all zeros. A pruning loss of the block can be computed measuring the error introduced by such a pruning operation. Unified weights in a block are set to follow a pre-defined unification rule, e.g., all values are set to be the same so that one value can be used to represent the whole block in the quantization process which yields high efficiency. There can be multiple rules of unifying weights, each associated with a unification distortion loss measuring the error introduced by taking this rule. For example, instead of setting the weights to be the same, the weights are set to have the same absolute value while keeping their original signs. Given this micro-structure, during an iteration, the part of the weight coefficients to be pruned or unified is determined by taking into consideration the pruning loss and the unification loss. Then, in the second step, the pruned and unified weights are fixed, and the normal neural network training process is performed and the remaining un-fixed weight coefficients are updated through the back-propagation mechanism.

FIGS. 4D and 4E are two embodiments of the iterative retraining/finetuning process, both iteratively alternate two steps to optimize the joint loss of Equation (11) gradually. Given a pre-trained DNN model with weight coefficients {W} and mask {M}, which can be either a pruned sparse model or an un-pruned non-sparse model, in the first step, both embodiments first reshape the weight coefficients W (and the corresponding mask M) of each layer into the desired 3D tensor or 2D matrix. Then for each layer, the micro-structure selection module 455 determines a set of pruning micro-structures {bₛ} or PMB whose weights will be pruned, and a set of unification micro-structures {bᵤ} or unification micro-structure blocks (UMB) are determined whole weights will be unified, through a Pruning and Unification Micro-Structure Selection process. There are multiple ways to determine the pruning micro-structures {bₛ} and of unification micro-structures {bᵤ}, four methods are listed here. In method 1, for each layer with weight coefficient W and mask M, for each block b in W, the weight unifier is used to unify weight coefficients within the block (e.g., by setting all weights to have the same absolute value while keeping the original signs). Then corresponding unification loss Lᵤ(b) is computed to measure the unification distortion (e.g., the L_{N} norm of the absolute of weights in b). The unification loss Lᵤ(W) can be computed as the summation of Lᵤ(b) across all blocks in W. Based on this unification loss Lᵤ(W), all layers of the DNN model are ranked according to Lᵤ(W) in accenting order. Then given a unification ratio u, the top layers whose micro-structure blocks will be unified (i.e., {bᵤ} includes all blocks for the selected layer) are selected, so that the actual unification ratio u′ (measured by ratio of the total number of unified micro-structure blocks of the selected layers versus the total number of micro-structure blocks of the entire DNN model) is closest to but still smaller than u %. Then, for each of the remaining layers, for each micro-structure block b, the pruning loss Lₛ(b) (e.g., the summation of the absolute of weights in b) is computed. Given a pruning ratio p, the blocks of this layer are ranked according to Lₛ(b) in accenting order, and the top p % blocks are selected as {bₛ} to be pruned. For the remaining blocks of this layer, an optional additional step can be taken, in which the remaining blocks of this layer are ranked based on the unification loss Lᵤ(b) in accenting order, and select the top (u−u′) % as {bᵤ} to be unified.

In method 2, for each layer with weight coefficient W and mask M, the unification loss Lᵤ(b) and Lᵤ(W) is computed in a similar way as the method 1. Then given a unification ratio u, the top layers whose micro-structure blocks will be unified in a similar way as the method 1. Then, the pruning loss Lₛ(b) of the remaining layers is computed in the same way as the method 1. Given a pruning ratio p, all the blocks of all the remaining layers are ranked according to Lₛ(b) in accenting order, and the top p % blocks are selected to be pruned. For the remaining blocks of the remaining layers, an optional additional step can be taken, in which the remaining blocks of the remaining layers are ranked based on the unification loss Lᵤ(b) in accenting order, and select the top (u−u′) % as {bᵤ} to be unified.

In method 3, for each layer with weight coefficients W and mask M, for each block b in W, the unification loss Lᵤ(b) and pruning loss L_{S}(b) are computed in the same way as method 1. Given the pruning ratio p and unification ratio u, the blocks of this layer are ranked according to Lₛ(b) in accenting order, and the top p % blocks are selected as {bₛ} to be pruned. For the remaining blocks of this layer, they are ranked based on the unification loss Lᵤ(b) in accenting order, and then select the top u % as {bᵤ} to be unified.

In method 4, for each layer with weight coefficients W and mask M, for each block b in W, the unification loss Lᵤ(b) and pruning loss Lₛ(b) are computed in the same way as method 1. Given the pruning ratio p and unification ratio u, all the blocks are ranked from all the layers of the DNN model according to Lₛ(b) in accenting order, and the top p % blocks are selected to be pruned. For the remaining blocks of the entire model, they are ranked based on the unification loss Lᵤ(b) in accenting order, and then select the top u % to be unified.

After obtaining the set of pruning micro-structure and the set of unification micro-structure, the target turns to finding a set of updated optimal weight coefficients W* and the corresponding weight mask M* by iteratively minimizing the joint loss described in Equation (11) are selected. In the first embodiment illustrated by FIG. 4D, for the t-th iteration, there are the current weight coefficients W(t−1). Also, a micro-structurally unifying mask U(t−1) and micro-structurally pruning mask P(t−1) are maintained throughout the training process. Both U(t−1) and P(t−1) has the same shape as W(t−1), recording whether a corresponding weight coefficient is unified or pruned, respectively. Then, the weight pruning/unification module 460 computes a pruned and unified weight coefficients W_{PU}(t−1) through a Weight Pruning and Unification process, in which selected pruning micro-structures masked by P(t−1) are pruned and weights in the selected unification micro-structures masked are unified by U(t−1), resulting an updated weight mask M_{PU}(t−1). In embodiments, M_{PU}(t−1) is different from the pre-training pruning mask M, in which for a block having both pre-pruned and unpre-pruned weight coefficients, the originally pruned weight coefficients will be set to have a non-zero value again by the weight unifier, and the corresponding item in M_{PU}(t−1) will be changed. In another embodiment, M_{PU}(t−1) is the same with M, in which for the blocks having both pruned and unpruned weight coefficients, only the unpruned weights will be reset, while the pruned weights remain to be zero.

Then in the second step, the weight update module 465 fixes the weight coefficients that are marked by U(t−1) and P(t−1) as being micro-structurally unified or micro-structurally pruned, and then updates the remaining unfixed weight coefficients of W(t−1) through a neural network training process, resulting in updated W(t) and M(t).

Specifically, let [symbol] ={(x,y)} denote a training dataset, where [symbol] can be the same as the original dataset [symbol] ₀={(x₀,y₀)} based on which the pre-trained weight coefficients W are obtained. [symbol] can also be a different dataset from [symbol] ₀, but with the same data distribution as the original dataset [symbol] . In the second step, the network forward computation module 415 passes each input x though the current network via a Network Forward Computation process using the current weight coefficients W_{U}(t−1) and mask M, which generates an estimated output y. Based on the ground-truth annotation y and the estimated output y, the target loss computation module 420 computes the target training loss £_{T}( [symbol] |Θ) in Equation (11) through a Compute Target Loss process. Then, the gradient computation module 425 computes the gradient of the target loss G(W_{U}(t−1)). The automatic gradient computing method used by deep learning frameworks such as tensorflow or pytorch can be used to compute G(W_{U}(t−1)). Based on the gradient G(W_{U}(t−1)) and the micro-structurally unifying mask U(t−1) and the micro-structurally pruning mask P(t−1), the weight update module 465 updates the non-fixed weight coefficients of W_{U}(t−1) through back-propagation using a Back Propagation and Weight Update process. The retraining process is also an iterative process itself. Multiple iterations are taken to update the non-fixed parts of W_{U}(t−1), e.g., until the target loss converges. Then the system goes to the next iteration t, in which given a new unification ratio u(t) and pruning ratio p(t), a new set of unifying micro-structures and pruning micro-structures (as well as the new micro-structurally unifying mask U(t) and micro-structurally pruning mask P(t)) are determined through the Pruning and Unification Micro-Structure Selection process.

In the second embodiment of the training process illustrated by FIG. 4E, the set of updated optimal weight coefficients W* and the corresponding weight mask M* are found by another iterative process. For the t-th iteration, there are the current weight coefficients W(t−1) and mask M. Also, the mask computation module 470 computes a micro-structurally unifying mask U(t−1) and micro-structurally pruning mask P(t−1) through a Pruning and Unification Mask Computation process. Both U(t−1) and P(t−1) has the same shape as W(t−1), recording whether a corresponding weight coefficient is unified or pruned, respectively. Then, the weight pruning/unification module 460 computes a pruned and unified weight coefficients W_{PU}(t−1) through a Weight Pruning and Unification process, in which the selected pruning micro-structures masked by P(t−1) are pruned and weights in the selected unification micro-structures masked are unified by U(t−1), resulting an updated weight mask M_{PU}(t−1)

Then in the second step, the weight update module 465 fixes the weight coefficients which are marked by U(t−1) and P(t−1) as being micro-structurally unified or micro-structurally pruned, and then updates the remaining unfixed weight coefficients of W(t−1) through a neural network training process, resulting in updated W(t). Similar to the first embodiment of FIG. 4D, given training dataset [symbol] ={(x,y)}, the network forward computation module 415 passes each input x though the current network via a Network Forward Computation process using the current weight coefficients W(t−1) and mask M(t−1), which generates an estimated output y̅. Based on the ground-truth annotation y and the estimated output y̅, the target loss computation module 420 computes a joint training loss £_{J}( [symbol] |Θ) including the target training loss £_{T}( [symbol] |Θ) in Equation (11) and a residue loss £ᵣₑₛ(W(t−1)) through a Compute Joint Loss process, as described in Equation (5).

£ᵣₑₛ(W(t−1)) measures the difference between the current weights W(t−1) and the target pruned and unified weights W_{PU}(t−1). For example, the L₁ norm can be used:

£ᵣₑₛ(W(t−1))=∥W(t−1))−W_{PU}(t−1)∥ (14)

Then, the gradient computation module 425 computes the gradient of the joint loss G(W(t−1)). The automatic gradient computing method used by deep learning frameworks such as tensorflow or pytorch can be used to compute G(W(t−1)). Based on the gradient G(W(t−1)) and the micro-structurally unifying mask U(t−1) and the micro-structurally pruning mask P(t−1), the weight update module 465 updates the non-fixed weight coefficients of W(t−1) through back-propagation using a Back Propagation and Weight Update process. The retraining process is also an iterative process itself. Multiple iterations are taken to update the non-fixed parts of W(t−1), e.g., until the target loss converges. Then the system goes to the next iteration t, in which given a unification ratio u(t) and pruning ratio p(t), a new set of unifying micro-structures and pruning micro-structures (as well as the new micro-structurally unifying mask U(t) and micro-structurally pruning mask P(t)) are determined through the Pruning and Unification Micro-Structure Selection process.

During this whole iterative process, at a T-th iteration, a pruned and unified weight coefficients W_{PU}(T) can be computed through the Weight Pruning and Unification process, in which the selected pruning micro-structures masked by P(T) are pruned and weights in the selected unification micro-structures masked are unified by U(T), resulting an updated weight mask M_{PU}(T). Similar to the previous embodiment of FIG. 4D, M_{PU}(T) can be the same with the pre-pruning mask M, in which for a block having both pruned and unpruned weight coefficients, the originally pruned weight coefficients will be set to have a non-zero value again by the weight unifier, and the corresponding item in M_{PU}(T) will be changed. Also, M_{PU}(T) can be the same with M, in which for the blocks having both pruned and unpruned weight coefficients, only the unpruned weights will be reset, while the pruned weights remain to be zero. This W_{PU}(T) and M_{PU}(T) can be used to generate the final updated model W* and M*. For example, W*=W_{PU}(T), and M*=M·M_{PU}(T).

In embodiments, the hyperparameters u(t) and p(t) may increase their values during iterations as t increases, so that more and more weight coefficients will be pruned and unified and fixed throughout the entire iterative learning process.

The unification regularization targets improving the efficiency of further compression of the learned weight coefficients, speeding up computation for using the optimized weight coefficients. This can significantly reduce the DNN model size and speedup the inference computation.

Through the iterative retraining process, the method can effectively maintain the performance of the original training target and pursue compression and computation efficiency. The iterative retraining process also gives the flexibility of introducing different loss at different times, making the system focus on different target during the optimization process.

The method can be applied to datasets with different data forms. The input/output data are 4D tensors, which can be real video segments, images, or extracted feature maps.

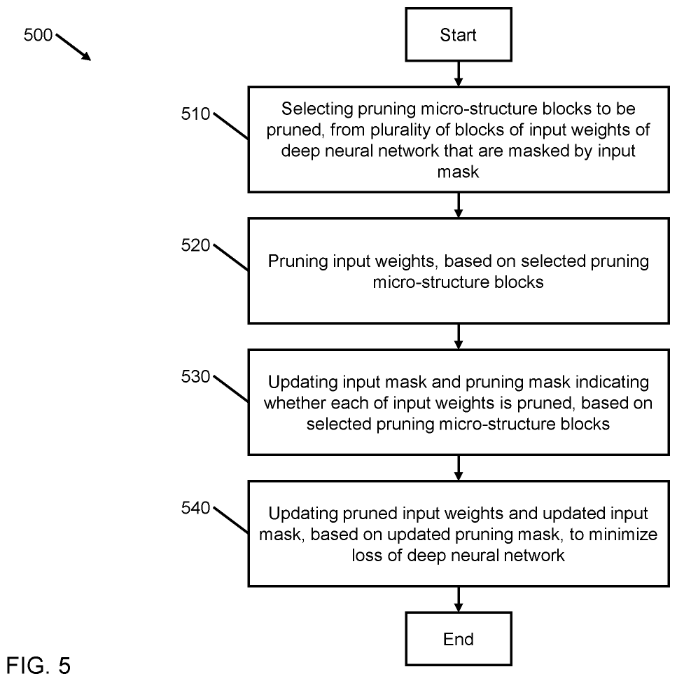

FIG. 5 is a flowchart of a method 500 of training neural network model compression with micro-structured weight pruning and weight unification, according to embodiments.

In some implementations, one or more process blocks of FIG. 5 may be performed by the platform 120. In some implementations, one or more process blocks of FIG. 5 may be performed by another device or a group of devices separate from or including the platform 120, such as the user device 110.

The method 500 is performed to train a deep neural network that is used to reduce parameters of an input neural network, to obtain an output neural network.

As shown in FIG. 5, in operation 510, the method 500 includes selecting pruning micro-structure blocks to be pruned, from a plurality of blocks of input weights of the deep neural network that are masked by an input mask.

In operation 520, the method 500 includes pruning the input weights, based on the selected pruning micro-structure blocks.

In operation 530, the method 500 includes updating the input mask and a pruning mask indicating whether each of the input weights is pruned, based on the selected pruning micro-structure blocks.

In operation 540, the method 500 includes updating the pruned input weights and the updated input mask, based on the updated pruning mask, to minimize a loss of the deep neural network.

The updating of the pruned input weights and the updated input mask may include reducing parameters of a first training neural network, to estimate a second training neural network, using the deep neural network of which the input weights are pruned and masked by the updated input mask, determining the loss of the deep neural network, based on the estimated second training neural network and a ground-truth neural network, determining a gradient of the determined loss, based on the pruned input weights, and updating the pruned input weights and the updated input mask, based on the determined gradient and the updated pruning mask, to minimize the determined loss.

The deep neural network may be further trained by reshaping the input weights masked by the input mask, partitioning the reshaped input weights into the plurality of blocks of the input weights, unifying multiple weights in one or more of the plurality of blocks into which the reshaped input weights are partitioned, among the input weights, updating the input mask and a unifying mask indicating whether each of the input weights is unified, based on the unified multiple weights in the one or more of the plurality of blocks, and updating the updated input mask and the input weights among which the multiple weights in the one or more of the plurality of blocks are unified, based on the updated unifying mask, to minimize the loss of the deep neural network.

The updating of the updated input mask and the input weights may include reducing parameters of a first training neural network, to estimate a second training neural network, using the deep neural network of which the input weights are unified and masked by the updated input mask, determining the loss of the deep neural network, based on the estimated second training neural network and a ground-truth neural network, determining a gradient of the determined loss, based on the input weights among which the multiple weights in the one or more of the plurality of blocks are unified, and updating the pruned input weights and the updated input mask, based on the determined gradient and the updated unifiying mask, to minimize the determined loss.

The deep neural network may be further trained by selecting unification micro-structure blocks to be unified, from the plurality of blocks of the input weights masked by the input mask, unifying multiple weights in one or more of the plurality of blocks of the pruned input weights, based on the selected unification micro-structure blocks, to obtain pruned and unified input weights of the deep neural network, and updating a unifying mask indicating whether each of the input weights is unified, based on the unified multiple weights in the one or more of the plurality of blocks. The updating the input mask may include updating the input mask, based on the selected pruning micro-structure blocks and the selected unification micro-structure blocks, to obtain a pruning-unification mask. The updating the pruned input weights and the updated input mask may include updating the pruned and unified input weights and the pruning-unification mask, based on the updated pruning mask and the updated unifying mask, to minimize the loss of the deep neural network.

The updating of the pruned and unified input weights and the pruning-unification mask may include reducing parameters of a first training neural network, to estimate a second training neural network, using the deep neural network of which the pruned and unified input weights are masked by the pruning-unification mask, determining the loss of the deep neural network, based on the estimated second training neural network and a ground-truth neural network, determining a gradient of the determined loss, based on the input weights among which the multiple weights in the one or more of the plurality of blocks are unified, and updating the pruned and unified input weights and the pruning-unification mask, based on the determined gradient, the updated pruning mask and the updated unifying mask, to minimize the determined loss.

The pruning micro-structure blocks may be selected from the plurality of blocks of the input weights masked by the input mask, based on a predetermined pruning ratio of the input weights to be pruned for each iteration.

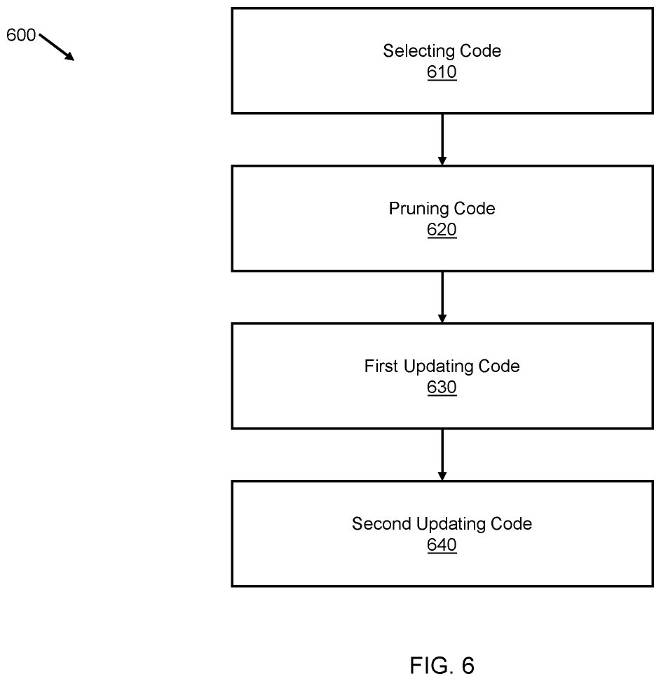

FIG. 6 is a diagram of an apparatus 600 for training neural network model compression with micro-structured weight pruning and weight unification, according to embodiments.

As shown in FIG. 6, the apparatus 600 includes selecting code 610, pruning code 620, first updating code 630 and second updating code 640.

The apparatus 600 trains a deep neural network that is used to reduce parameters of an input neural network, to obtain an output neural network.

The selecting code 610 is configured to cause at least one processor to selects pruning micro-structure blocks to be pruned, from a plurality of blocks of input weights of the deep neural network that are masked by an input mask;

The pruning code 620 is configured to cause at least one processor to prune the input weights, based on the selected pruning micro-structure blocks.

The first updating code 630 is configured to cause at least one processor to update the input mask and a pruning mask indicating whether each of the input weights is pruned, based on the selected pruning micro-structure blocks.

The second updating code 640 is configured to cause at least one processor to update the pruned input weights and the updated input mask, based on the updated pruning mask, to minimize a loss of the deep neural network.

The second updating code 640 may be further configured to cause the at least one processor to reduce parameters of a first training neural network, to estimate a second training neural network, using the deep neural network of which the input weights are pruned and masked by the updated input mask, determine the loss of the deep neural network, based on the estimated second training neural network and a ground-truth neural network, determine a gradient of the determined loss, based on the pruned input weights, and update the pruned input weights and the updated input mask, based on the determined gradient and the updated pruning mask, to minimize the determined loss.

The deep neural network may be further trained by reshaping the input weights masked by the input mask, partitioning the reshaped input weights into the plurality of blocks of the input weights, unifying multiple weights in one or more of the plurality of blocks into which the reshaped input weights are partitioned, among the input weights, updating the input mask and a unifying mask indicating whether each of the input weights is unified, based on the unified multiple weights in the one or more of the plurality of blocks, and updating the updated input mask and the input weights among which the multiple weights in the one or more of the plurality of blocks are unified, based on the updated unifying mask, to minimize the loss of the deep neural network.

The second updating code 640 may be further configured to cause the at least one processor to reduce parameters of a first training neural network, to estimate a second training neural network, using the deep neural network of which the input weights are unified and masked by the updated input mask, determine the loss of the deep neural network, based on the estimated second training neural network and a ground-truth neural network, determine a gradient of the determined loss, based on the input weights among which the multiple weights in the one or more of the plurality of blocks are unified, and update the pruned input weights and the updated input mask, based on the determined gradient and the updated unifiying mask, to minimize the determined loss.

The deep neural network may be further trained by selecting unification micro-structure blocks to be unified, from the plurality of blocks of the input weights masked by the input mask, unifying multiple weights in one or more of the plurality of blocks of the pruned input weights, based on the selected unification micro-structure blocks, to obtain pruned and unified input weights of the deep neural network, and updating a unifying mask indicating whether each of the input weights is unified, based on the unified multiple weights in the one or more of the plurality of blocks. The updating the input mask may include updating the input mask, based on the selected pruning micro-structure blocks and the selected unification micro-structure blocks, to obtain a pruning-unification mask. The updating the pruned input weights and the updated input mask may include updating the pruned and unified input weights and the pruning-unification mask, based on the updated pruning mask and the updated unifying mask, to minimize the loss of the deep neural network.

The second updating code 640 may be further configured to cause the at least one processor to reduce parameters of a first training neural network, to estimate a second training neural network, using the deep neural network of which the pruned and unified input weights are masked by the pruning-unification mask, determine the loss of the deep neural network, based on the estimated second training neural network and a ground-truth neural network, determine a gradient of the determined loss, based on the input weights among which the multiple weights in the one or more of the plurality of blocks are unified, and update the pruned and unified input weights and the pruning-unification mask, based on the determined gradient, the updated pruning mask and the updated unifying mask, to minimize the determined loss.

The pruning micro-structure blocks may be selected from the plurality of blocks of the input weights masked by the input mask, based on a predetermined pruning ratio of the input weights to be pruned for each iteration.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein may be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of neural network model compression, the method being performed by at least one processor, and the method comprising:
receiving an input neural network and an input mask;
reducing parameters of the input neural network, using a deep neural network that is trained by:
selecting pruning micro-structure blocks to be pruned, from a plurality of blocks of input weights of the deep neural network that are masked by the input mask;
pruning the input weights, based on the selected pruning micro-structure blocks;
selecting unification micro-structure blocks to be unified, from the plurality of blocks of the input weights masked by the input mask; and
unifying multiple weights in one or more of the plurality of blocks of the pruned input weights, based on the selected unification micro-structure blocks, to obtain pruned and unified input weights of the deep neural network; and
obtaining an output neural network with the reduced parameters, based on the input neural network and the pruned and unified input weights of the deep neural network.

2. The method of claim 1, wherein the deep neural network is further trained by:
updating the input mask and a pruning mask indicating whether each of the input weights is pruned, based on the selected pruning micro-structure blocks; and
updating the pruned input weights and the updated input mask, based on the updated pruning mask, to minimize a loss of the deep neural network.

3. The method of claim 1, wherein the deep neural network is further trained by:
reshaping the input weights masked by the input mask;
partitioning the reshaped input weights into the plurality of blocks of the input weights;
unifying multiple weights in one or more of the plurality of blocks into which the reshaped input weights are partitioned, among the input weights;
updating the input mask and a unifying mask indicating whether each of the input weights is unified, based on the unified multiple weights in the one or more of the plurality of blocks; and
updating the updated input mask and the input weights among which the multiple weights in the one or more of the plurality of blocks are unified, based on the updated unifying mask, to minimize a loss of the deep neural network.

4. The method of claim 3, wherein the updating of the updated input mask and the input weights comprises:
reducing parameters of a first training neural network, to estimate a second training neural network, using the deep neural network of which the input weights are unified and masked by the updated input mask;
determining the loss of the deep neural network, based on the estimated second training neural network and a ground-truth neural network;
determining a gradient of the determined loss, based on the input weights among which the multiple weights in the one or more of the plurality of blocks are unified; and
updating the pruned input weights and the updated input mask, based on the determined gradient and the updated unifiying mask, to minimize the determined loss.

5. The method of claim 2, wherein the deep neural network is further trained by updating a unifying mask indicating whether each of the input weights is unified, based on the unified multiple weights in the one or more of the plurality of blocks,
wherein the updating the input mask comprises updating the input mask, based on the selected pruning micro-structure blocks and the selected unification micro-structure blocks, to obtain a pruning-unification mask, and
wherein the updating the pruned input weights and the updated input mask comprises updating the pruned and unified input weights and the pruning-unification mask, based on the updated pruning mask and the updated unifying mask, to minimize the loss of the deep neural network.

6. The method of claim 5, wherein the updating of the pruned and unified input weights and the pruning-unification mask comprises:
reducing parameters of a first training neural network, to estimate a second training neural network, using the deep neural network of which the pruned and unified input weights are masked by the pruning-unification mask;
determining the loss of the deep neural network, based on the estimated second training neural network and a ground-truth neural network;
determining a gradient of the determined loss, based on the input weights among which the multiple weights in the one or more of the plurality of blocks are unified; and
updating the pruned and unified input weights and the pruning-unification mask, based on the determined gradient, the updated pruning mask and the updated unifying mask, to minimize the determined loss.

7. The method of claim 1, wherein the pruning micro-structure blocks are selected from the plurality of blocks of the input weights masked by the input mask, based on a predetermined pruning ratio of the input weights to be pruned for each iteration.

8. An apparatus for neural network model compression, the apparatus comprising:
at least one memory configured to store program code; and
at least one processor configured to read the program code and operate as instructed by the program code, the program code comprising:
receiving code configured to cause the at least one processor to receive an input neural network and an input mask;
reducing code configured to cause the at least one processor to reduce parameters of the input neural network, using a deep neural network that is trained by:
selecting pruning micro-structure blocks to be pruned, from a plurality of blocks of input weights of the deep neural network that are masked by the input mask;
pruning the input weights, based on the selected pruning micro-structure blocks;
selecting unification micro-structure blocks to be unified, from the plurality of blocks of the input weights masked by the input mask; and
unifying multiple weights in one or more of the plurality of blocks of the pruned input weights, based on the selected unification micro-structure blocks, to obtain pruned and unified input weights of the deep neural network; and
obtaining code configured to cause the at least one processor to output an output neural network with the reduced parameters, based on the input neural network and the pruned and unified input weights of the deep neural network.

9. The apparatus of claim 8, wherein the deep neural network is further trained by:
updating the input mask and a pruning mask indicating whether each of the input weights is pruned, based on the selected pruning micro-structure blocks; and
updating the pruned input weights and the updated input mask, based on the updated pruning mask, to minimize a loss of the deep neural network.

10. The apparatus of claim 8, wherein the deep neural network is further trained by:
reshaping the input weights masked by the input mask;
partitioning the reshaped input weights into the plurality of blocks of the input weights;
unifying multiple weights in one or more of the plurality of blocks into which the reshaped input weights are partitioned, among the input weights;
updating the input mask and a unifying mask indicating whether each of the input weights is unified, based on the unified multiple weights in the one or more of the plurality of blocks; and
updating the updated input mask and the input weights among which the multiple weights in the one or more of the plurality of blocks are unified, based on the updated unifying mask, to minimize a loss of the deep neural network.

11. The apparatus of claim 10, wherein the updating of the updated input mask and the input weights comprises:
reducing parameters of a first training neural network, to estimate a second training neural network, using the deep neural network of which the input weights are unified and masked by the updated input mask;
determining the loss of the deep neural network, based on the estimated second training neural network and a ground-truth neural network;
determining a gradient of the determined loss, based on the input weights among which the multiple weights in the one or more of the plurality of blocks are unified; and
updating the pruned input weights and the updated input mask, based on the determined gradient and the updated unifiying mask, to minimize the determined loss.

12. The apparatus of claim 9, wherein the deep neural network is further trained by updating a unifying mask indicating whether each of the input weights is unified, based on the unified multiple weights in the one or more of the plurality of blocks,
wherein the updating the input mask comprises updating the input mask, based on the selected pruning micro-structure blocks and the selected unification micro-structure blocks, to obtain a pruning-unification mask, and
wherein the updating the pruned input weights and the updated input mask comprises updating the pruned and unified input weights and the pruning-unification mask, based on the updated pruning mask and the updated unifying mask, to minimize the loss of the deep neural network.

13. The apparatus of claim 12, wherein the updating of the pruned and unified input weights and the pruning-unification mask comprises:
reducing parameters of a first training neural network, to estimate a second training neural network, using the deep neural network of which the pruned and unified input weights are masked by the pruning-unification mask;
determining the loss of the deep neural network, based on the estimated second training neural network and a ground-truth neural network;
determining a gradient of the determined loss, based on the input weights among which the multiple weights in the one or more of the plurality of blocks are unified; and
updating the pruned and unified input weights and the pruning-unification mask, based on the determined gradient, the updated pruning mask and the updated unifying mask, to minimize the determined loss.

14. The apparatus of claim 8, wherein the pruning micro-structure blocks are selected from the plurality of blocks of the input weights masked by the input mask, based on a predetermined pruning ratio of the input weights to be pruned for each iteration.

15. A non-transitory computer-readable medium storing instructions that, when executed by at least one processor for neural network model compression, cause the at least one processor to:
receive an input neural network and an input mask;
reduce parameters of the input neural network, using a deep neural network that is trained by:
selecting pruning micro-structure blocks to be pruned, from a plurality of blocks of input weights of the deep neural network that are masked by the input mask;
pruning the input weights, based on the selected pruning micro-structure blocks;
selecting unification micro-structure blocks to be unified, from the plurality of blocks of the input weights masked by the input mask; and
unifying multiple weights in one or more of the plurality of blocks of the pruned input weights, based on the selected unification micro-structure blocks, to obtain pruned and unified input weights of the deep neural network; and
obtain an output neural network with the reduced parameters, based on the input neural network and the pruned and unified input weights of the deep neural network.

16. The non-transitory computer-readable medium of claim 15, wherein the deep neural network is further trained by:
updating the input mask and a pruning mask indicating whether each of the input weights is pruned, based on the selected pruning micro-structure blocks; and
updating the pruned input weights and the updated input mask, based on the updated pruning mask, to minimize a loss of the deep neural network.

17. The non-transitory computer-readable medium of claim 15, wherein the deep neural network is further trained by:
reshaping the input weights masked by the input mask;
partitioning the reshaped input weights into the plurality of blocks of the input weights;
unifying multiple weights in one or more of the plurality of blocks into which the reshaped input weights are partitioned, among the input weights;
updating the input mask and a unifying mask indicating whether each of the input weights is unified, based on the unified multiple weights in the one or more of the plurality of blocks; and
updating the updated input mask and the input weights among which the multiple weights in the one or more of the plurality of blocks are unified, based on the updated unifying mask, to minimize a loss of the deep neural network.

18. The non-transitory computer-readable medium of claim 17, wherein the updating of the updated input mask and the input weights comprises:
reducing parameters of a first training neural network, to estimate a second training neural network, using the deep neural network of which the input weights are unified and masked by the updated input mask;
determining the loss of the deep neural network, based on the estimated second training neural network and a ground-truth neural network;
determining a gradient of the determined loss, based on the input weights among which the multiple weights in the one or more of the plurality of blocks are unified; and
updating the pruned input weights and the updated input mask, based on the determined gradient and the updated unifiying mask, to minimize the determined loss.

19. The non-transitory computer-readable medium of claim 16, wherein the deep neural network is further trained by updating a unifying mask indicating whether each of the input weights is unified, based on the unified multiple weights in the one or more of the plurality of blocks,
wherein the updating the input mask comprises updating the input mask, based on the selected pruning micro-structure blocks and the selected unification micro-structure blocks, to obtain a pruning-unification mask, and
wherein the updating the pruned input weights and the updated input mask comprises updating the pruned and unified input weights and the pruning-unification mask, based on the updated pruning mask and the updated unifying mask, to minimize the loss of the deep neural network.

20. The non-transitory computer-readable medium of claim 19, wherein the updating of the pruned and unified input weights and the pruning-unification mask comprises:
reducing parameters of a first training neural network, to estimate a second training neural network, using the deep neural network of which the pruned and unified input weights are masked by the pruning-unification mask;
determining the loss of the deep neural network, based on the estimated second training neural network and a ground-truth neural network;
determining a gradient of the determined loss, based on the input weights among which the multiple weights in the one or more of the plurality of blocks are unified; and
updating the pruned and unified input weights and the pruning-unification mask, based on the determined gradient, the updated pruning mask and the updated unifying mask, to minimize the determined loss.
